(19) United States
(12) Patent Application Publication
(10) Pub. No.: US 2003/0194362 A1
(43) Pub. Date: Oct. 16, 2003

(54) Chemical reactor and fuel processor utilizing ceramic technology

(76) Inventors: Stephen P. Rogers, Phoenix, AZ (US); Chowdary Ramesh Koripella, Scottsdale, AZ (US); David Charles Lamont, Kennewick, WA (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/121,902

(22) Filed: Apr. 12, 2002

(51) Int. Cl. B01J 8/02; F23D 21/00

(52) U.S. Cl. 422/222; 422/211; 422/198; 422/110

(57) ABSTRACT

A multilayered ceramic chemical reactor and method of making the chemical reactor for use in an integrated fuel reformer in the form of a chemical combustion heating reactor or a steam reforming reactor. The ceramic chemical reactor including a three-dimensional multilayer ceramic carrier structure defining a cavity having a cofired porous ceramic support layer formed therein. The porous ceramic support layer further includes an immobilized catalyst formed on a surface of the porous ceramic support layer or entrapped within a plurality of voids formed in the porous ceramic support layer. The immobilized catalyst providing for a chemical reaction which converts input chemical reactants into chemical products and by-products. The cavity further includes a fuel inlet, an air inlet, and an outlet. The fuel processor includes a monolithic three-dimensional multilayer ceramic carrier structure defining a fuel reforming reactor, having heat provided by the integrated chemical reactor.

### FIELD OF INVENTION

The present invention pertains to ceramic technology devices, and more particularly to a chemical reactor and a fuel processor, fabricated utilizing ceramic technology for improved size and performance benefits.

### BACKGROUND OF THE INVENTION

Fuel cell systems for man-portable electrical power supplies, in general, are “battery replacements”. Like batteries, fuel cells produce electricity through an electrochemical process, more specifically, a fuel cell produces electricity from fuel and air without combustion. The electrochemical process utilized provides for the combining of hydrogen, the fuel, with oxygen from the air. The process is accomplished utilizing an electrolyte, such as a polymer electrolyte membrane (PEM), which conducts ions, such as protons. The PEM is sandwiched between two electrodes, namely an anode, the negative electrode used for hydrogen oxidation, and a cathode, the positive electrode used for oxygen reduction. Fuel cells, as known, can perpetually provide electricity as long as fuel and oxygen are supplied. Hydrogen is typically used as the fuel in fuel cells for producing the electricity and it can be processed from methanol, natural gas, petroleum, ammonia, or stored in metal hydrides, carbon nanotubes, or as pure hydrogen. Reformed hydrogen fuel cells (RHFCs) utilize hydrogen fuel processed from liquid or gaseous hydrocarbon fuels, such as methanol, using a reactor, called a fuel reformer, for converting the fuel into hydrogen.

Reformed hydrogen fuel cells preferably utilize methanol that is reformed into hydrogen as a fuel source. Methanol is the preferred fuel for use in fuel reformers for portable applications because it is easier to reform into hydrogen gas at a relatively low temperature compared to other hydrocarbon fuels such as ethanol, gasoline, or butane. The reforming or converting of methanol into hydrogen usually takes place by one of three different types of reforming. These three types are steam reforming, partial oxidation reforming, and autothermal reforming. Of these types, steam reforming is the preferred process for methanol reforming because it is the easiest to control and produces a higher concentration of hydrogen output by the reformer, at a lower temperature, thus lending itself to favored use.

Fuel reformers have been developed for use in conjunction with fuel cell devices, but they are typically cumbersome and complex systems consisting of several discrete sections connected together with gas plumbing and hardware to produce hydrogen gas, and are thus not suitable for portable power source applications. Recently fuel reformers have been developed utilizing ceramic monolithic structures in which the miniaturization of the reformer can be achieved. Utilizing multilayer laminated ceramic technology, ceramic components and systems are now being developed for use in microfluidic chemical processing and energy management systems. Monolithic structures formed of these laminated ceramic components are inert and stable to chemical reactions and capable of tolerating high temperatures. These structures can also provide for miniaturized components, with a high degree of electrical and electronic circuitry or components embedded or integrated into the ceramic structure for system control and functionality. Additionally, the ceramic materials used to form ceramic components or devices, including microchanneled configurations, are considered to be excellent candidates for catalyst supports and so are extraordinarily compatible for use in microreactor devices for generating hydrogen used in conjunction with miniaturized fuel cells. During steam reforming, raw methanol is catalytically converted, with the application of heat, to a hydrogen enriched fuel gas for use with fuel cells. As previously stated, a common means for converting of methanol into hydrogen takes place by steam reforming. Typically, a steam reformer is endothermically operated at an elevated temperature (180°-300° C.), thereby ensuring the reforming reaction is maintained in its optimal operating temperature. Common means for generating these elevated temperatures has been found using conventional electrical heaters and chemical reactors for large reformer reactors. Conventional electrical heating has been demonstrated in multilayered ceramic methanol steam reformer reactors for miniaturized applications. At this time there exists a desire to further miniaturize and integrate this means of heating to achieve steam reforming and develop a miniature in-situ chemical reactors which includes catalysts, for portable applications such as elevated temperature fuel cells, microturbines, thermoelectrics, fuel gas production, and the like.

It is well known in the art that metal species catalysts supported on a porous ceramic materials of high surface area, usually take the form of bulk loose catalyst powders, or are pressed into catalyst pellets. In small-scale applications involving miniature devices and reactors with meso scale (meso reactors with structural features on the order of millimeter dimensions) and micro scale (micro reactors with structural features on the order of micrometer to millimeter dimensions) features, including channels and other miniature device structures, pellets are not feasible due to their size. Both catalyst pellets and powders are not stable in reactor packed catalyst bed configurations due to pellet fracture and changes in catalyst bed packing density during use. Shifting or movement of the packed catalyst bed leads to the formation of channels, voids, or cakes; i.e., more densely packed catalyst, within the catalyst packing, all of which change catalyst utilization and reactor performance. While this often has no noticeable impact on performance in larger devices, there can be severely diminished performance in miniature devices and reactors. Accordingly, in miniature devices and reactors, it would be more desirable to have an immobilized support that retains the high porosity and surface area possible with bulk powders. The immobilized catalyst should be positioned in such a way as to allow reactants to intimately contact the immobilized catalyst, while not degrading the catalytic activity of the catalyst.

Accordingly, it is an object of the present invention to provide for a miniaturized chemical reactor including a porous ceramic material having a catalyst immobilized within or upon the porous ceramic material and a method of fabricating the miniaturized chemical reactor including the porous ceramic material and immobilized catalyst.

It is another object of the present invention to provide for a miniaturized chemical reactor wherein the chemical reactor is formed as a chemical combustion heating reactor or a steam reforming reactor.

It is another object of the present invention to provide for a miniaturized chemical reactor including a porous ceramic material having a catalyst immobilized within or upon the porous ceramic material and a method of fabricating the miniaturized chemical reactor utilizing ceramic technology.

It is another object of the present invention to provide for a miniaturized chemical reactor including a porous ceramic material having a catalyst immobilized within or upon the porous ceramic material and method of fabricating the miniaturized chemical reactor wherein the ceramic structure and the porous ceramic material are cofired during fabrication, and thereafter having a catalyst impregnated therein, thus providing for reactants to intimately contact the immobilized catalyst during use, without degrading the catalytic activity of the catalyst.

It is another object of the present invention to provide for a multilayer chemical reactor including a porous ceramic material having a catalyst immobilized within or upon the porous ceramic material that is miniaturized for use in conjunction with an integrated fuel cell system for portable device applications.

It is yet another object of the present invention to provide for a monolithic multilayer ceramic fuel processor including an integrated steam reforming chemical reactor including a porous ceramic material having a catalyst immobilized within or upon the porous ceramic material and an integrated chemical combustion heating reactor including a porous ceramic material having a catalyst immobilized within or upon the porous ceramic material of the present invention.

### SUMMARY OF THE INVENTION

The above problems and others are at least partially solved and the above purposes and others are realized in a multilayered ceramic chemical reactor and method of fabricating miniature reactors, including a ceramic carrier structure, and a porous ceramic support material which may serve as an intermediate barrier layer when necessary, having a catalyst material immobilized within or upon the porous ceramic support layer. Additionally, disclosed is the integration of miniature reactors into a fuel processing system with components such as a chemical reactor, steam reformer, and a fuel cell.

### BRIEF DESCRIPTION OF THE DRAWINGS

The novel features believed characteristic of the invention are set forth in the claims. The invention itself, however, as well as other features and advantages thereof will be best understood by reference to detailed descriptions which follow, when read in conjunction with the accompanying drawings, wherein:

FIG. 1 is a simplified sectional view of a first embodiment of a chemical reactor, according to the present invention;

FIG. 2 is a simplified sectional view of a second embodiment of a chemical reactor, according to the present invention;

FIG. 3 is a simplified sectional view of a fuel processor including a chemical reactor for reforming methanol to hydrogen, a chemical combustion heater for providing heat, and an integrated fuel cell stack according to the present invention; and

FIG. 4 is a schematic diagram of a fuel cell system including integrated chemical reactors for chemical combustion heating and steam reforming as a fuel processing system according to the present invention.

### DESCRIPTION OF THE PREFERRED EMBODIMENTS

The chemical reactors of the present invention are anticipated for use in a fuel processor, or more specifically as a chemical combustion heater and a fuel reformer, that include vaporization zones and reaction zones with appropriate catalyst for reactions that produce heat in the chemical combustion heating reactor and hydrogen enriched gas in the fuel reforming reactor. The chemical combustion heating reactor is thermally coupled to the vaporization and reaction zones of the fuel reformer. The chemical reactors are formed utilizing ceramic technology in which thin ceramic layers are assembled then sintered to provide miniature dimensions in which the encapsulated catalyst converts the inlet fuels into product materials such as water vapor, carbon dioxide, carbon monoxide, nitrogen (from the air) and hydrogen gases, and heat.

Miniature reactors are designed for use in an integrated fuel processor including a three-dimensional multilayer ceramic carrier structure defining at least one ceramic cavity having a geometric surface area. The porous ceramic support layer which is an intermediate porous ceramic support layer is formed within the cavity in a planar or channeled configuration, and is characterized as having a real surface area greater than the geometric surface area of the cavity. The ceramic structure and the porous ceramic support layer are cofired prior to the introduction of a catalyst material, thereby providing for a porous region of high specific surface area suitable for a catalytic support that is well adhered to the ceramic structure. Subsequent to firing, the porous ceramic support material is impregnated with an appropriate catalytic precursor material to complete synthesis of the immobilized catalyst.

The cavity further includes chemical reactant inlets such as a fuel inlet, an air inlet, and an outlet for reaction products as well as any unreacted input materials. Optionally included is at least one temperature sensor. The temperature sensor is provided to permit feedback control of the feed rate of the input materials. This feedback control of the feed rate of the input materials allows for the maintenance of the reactor at a specific temperature and feed rate. Additionally, disclosed is the integration of miniature reactors into a fuel processing system with components such as a chemical reactor, steam reformer, and a fuel cell.

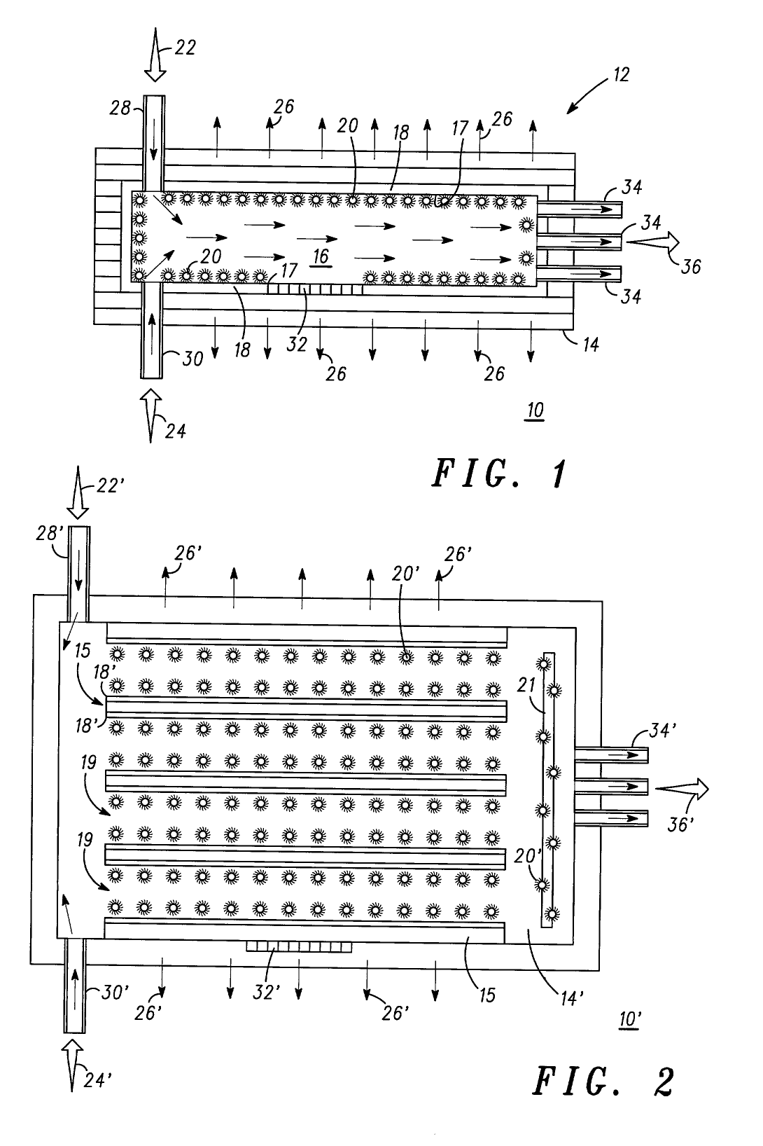

Turning now to the drawings, and in particular FIG. 1, illustrated in simplified sectional view is a chemical reactor 10 according to the present invention. Chemical reactor 10 is formed using multi-layer ceramic technology, and is defined by a ceramic structure 12. More particularly, chemical reactor 10 is comprised of a plurality of ceramic layers 14 that are sintered together during processing to form reactor 10, which in this particular embodiment is formed as a chemical combustion heating reactor. Ceramic structure 12 defines a ceramic cavity 16 therein. Ceramic cavity 16 provides for the control of flow of input materials such as fuel and air (discussed presently). Ceramic cavity 16 is further described as having a geometric surface area as evidenced by a plurality of surfaces 17 that define ceramic cavity 16. A porous ceramic support layer 18 is formed within ceramic cavity 16 and is characterized as having a real surface area greater than the geometric surface area of ceramic cavity 16. Porous ceramic support layer 18 is disclosed as being formed of a high surface area material, such as a porous ceramic material, thereby characterized as a pure high surface area support. It is anticipated by this disclosure that porous ceramic support layer 18 can additionally act as a barrier layer to prevent catalyst poisoning from the substrate such as from the glass binder or lead formulated in the ceramic tapes which are utilized to fabricate ceramic monoliths.

During fabrication of device 10, plurality of ceramic layers 14 forming dense ceramic structure 12 and porous ceramic support layer 18 are cofired together. Porous ceramic support layer 18 is further described as being deposited on surfaces 17 of plurality of ceramic layers 14 and within cavity 16 in a planar (shown) or channeled configuration. Typically, porous ceramic support layer 18 is screen printed from a thick film paste, or deposited via a slurry coating, onto ceramic structure 12 in its green or unfired state during assembly. Porous ceramic support layer 18 is then cofired with the green ceramic structure 12 to yield a porous region of high specific surface area suitable for a catalytic support that is well adhered to the dense ceramic structure 12.

Next, a catalyst material 20 is formed in combination with porous ceramic support layer 18. More particularly, catalyst material 20 in this particular embodiment is described as an impregnated catalyst formed on or within porous ceramic support layer 18. In the example of a chemical combustion heating reactor, catalyst 20 is characterized as providing for complete air oxidation of an input chemical reactants, including fuel 22 with air 24, and the generation of heat 26 in proportion to the feed rate of input fuel 22 and air 24. In the example of a steam reforming reactor, catalyst 20 is characterized as providing for the chemical conversion of input material 22 and steam 24 and the absorption of heat 26 in proportion to the feed rate of input material 22 and steam 24.

Porous ceramic support layer 18 is described as being a high surface area support, such as alumina (Al₂O₃), silica (SiO₂), titanium dioxide (TiO₂), zirconium dioxide (ZrO₂), cerium dioxide (CeO₂), lanthanum oxide (La₂O₃), or a combination of at least two of these high surface area supports. Catalyst 20 in a preferred embodiment is formed by the impregnation of hydrated metal salts, such as cupric nitrate (Cu(NO₃)₂.3H₂O), zinc nitrate (Zn(NO₃)₂.6H₂O), dihydrogenhexachloroplatinate (H₂PtCl₆.6H₂O), or palladium nitrate (Pd(NO₃)₂.2H₂O) which are then fired to decompose the salts to their metallic catalytic species. Alternatively, catalyst 20 is formed of an active metal such as silver (Ag), palladium (Pd), nickel (Ni), or the like. Various active metal oxides, active metal oxychlorides and active metal oxynitrides can act as alternative catalyst materials to noble metals like platinum (Pt) as combustion catalysts and as performance enhancing supports for combustion catalyst materials. These mixed metal ionic species have compositions of positive metal ions, like ferrous ion (Fe⁺²) or ferric ion (Fe⁺³), and negative ions, like oxide ion (0⁻²), chloride (Cl⁻¹), or nitride (N⁻³).

Active transition metal oxides such as a manganese oxide (MnO, MnO₄, MnO₆), cobalt oxide (Co₂O₃), molybdenum oxide (MoO₂, Mo₂O₃, or Mo₂O₅), chrome oxide (Cr₂O₃), can be defined using iron oxide (FeₓO_{y}) as an example, where a family of active metal oxides (MₓO_{y}) with M is any transition metal, preferably from Groups VIA, VIIA, and VIIIA, consisting of active metal oxides with x=1 and y=1 (e.g., FeO) or x=2 and y=3 (e.g., Fe₂O₃), and admixtures thereof (e.g., Fe₃O₄ forms by mixing the FeO and Fe₂O₃ in a 1 to 1 ratio). In general, these active metal oxides can be expressed as M_{x+x′}O_{y+y′:}

e.g., for FeO, FeₓO_{y} with x=0 to 1 and y=x;

and for Fe₂O₃ we have x′=0 to 2 and y′=3/2x′y′=y(3/2),

and then admixtures thereof can be formulated as Fe_{x+x′}O_{y+y′}.

e.g., for the 1 to 1 iron oxide admixture, Fe₃O₄;

we have x=1, x′=2 and y=1 and y′=3.

Using iron oxide (FeₓO_{y}) as an example, a family of active metal oxychlorides can be defined and expressed as, M_{x+x′}O_{y+y′}Cl_{z+z′}, where M is any transition metal, preferably from Groups VIA, VIIA, and VIIIA of the Periodic Table, and x=1 or 2, y=1 or 3, and z=0 to 6.

e.g., for FeO_{y-z}Cl_{z}, x=1, y=x−z/2 and z=0 to 2x;

for Fe_{x′}O_{y′}Cl_{z′}, x′=1 or 2 and y′=(3/2)*x′-z′/2 and z′=0 to 3x

e.g., for Fe₂O₂Cl₂ x′=2; z′=1x; then y′=(3/2)*2-2/2=2

and admixtures there of, Fe_{x+x′}O_{y+y′}Cl_{z+z′}

and for Fe₃O₃Cl₂, x=1, x′=2; z=2x=2; so y=x-z/2=0; z′=0 so y′=3/2*x′-z′=3 By analogy, similar formulations can be made for active metal oxynitrides and their mixtures with chloride and all admixtures.

If a cation such as Pt(IV) is substituted for iron in the iron oxides and analogues examples, then substitution in iron oxide example would yield an active mixed metal oxide, in general this can be formulated as PtₐFeₓO_{y} where a=0 to 1 and x=0 to 1 and y=x+2a. For the active mixed metal oxide case where a=¼ and x=½, then y=1, would describe Pt_{1/4}Fe_{1/2}O or PtFe₂O₄. Mixed active metal oxychloride and oxynitrides can be formulated by substitution of this formulation into proper generator expressions in analogy to those above for iron species.

The principle benefit of having the positively charged metal ion with various oxide, chloride and nitride negative ions and mixed-negative-ions is this gives a metal for tailoring the metal ion for catalyzing specific chemical reactions and yet promote stability of chemically active metal ions catalysts. In general other metals and combinations of metals with anions, e.g., like ZrOCl₂, AlOCl, and mixed metal oxychlorides and oxynitrides, etc., can be useful as combustion catalysts and supports for combustion catalysts, and it should additionally be understood that anticipated is a catalyst 20 formed of any combination of active metals, active metal oxides, active metal oxychlorides, and active metal oxynitrides.

Catalyst 20 is disclosed as being formed on a surface 22 of porous ceramic support layer 18. Porous ceramic support layer 18 provides for a more efficient device 10 in that porous ceramic support layer 18 provides for a greater real surface area due to its porosity than the geometric area of cavity 16, and thus provides for maximum utilization of catalyst 20 and maximum optimization of the extent of chemical conversion of chemical reactants such as fuel 22 and oxidant air 24 for chemical combustion for heat generation. Porous ceramic support layer 18 provides for a more efficient and cost effective device 10 in that porous ceramic support layer 18 provides for enhanced dispersion and therefore utilization of catalyst 20, for enhanced catalytic activity for chemical reactions such as chemical combustion process for heating and methanol steam reforming for enriched gas generation and for enhanced stability of catalyst 20, that is activity of catalyst 20 in time. These enhancements with catalyst 20 on porous ceramic support layer 18 result from catalyst 20 being isolated from any other materials except chemical reactants such as fuel 22, air 24 and porous ceramic support layer 18, and the increased dispersion of the catalysts, that is an increased surface area of the catalyst per unit of mass of catalyst 20 resulting when catalyst 20 is dispersed by depositing catalyst 20 onto porous ceramic support layer 18. Typically this high catalyst 20 surface area results by dispersing a mass, a, of catalyst 20 by depositing a negligible volume of catalyst 20 material as a thin shell onto the surfaces 22 of porous ceramic support layer 18 with a mass, b, and of a volume, x. Catalyst 20 and porous ceramic support layer 18 composite essentially has a volume, x, which is virtually the same as the geometric volume, x, of the porous ceramic only. This composite volume of catalyst 20 and porous ceramic support layer 18 behaves like a volume, x. A mass, c, of catalyst 20 in the composite volume would be the volume, x, times the density of the catalyst 20. A mass, a, for catalyst 18 filling the whole volume, x, would be much greater than catalyst 20 mass, c. The enhanced dispersion of catalyst 20 would be proportional to the factor, c/a, which is the equivalent mass of pure catalyst 20 filling the whole volume, x, divided by the mass, a, of the catalyst 20 deposited on the surface of a volume, x, of the porous ceramic support layer 18. The factor c/a is a factor for calculating the beneficial cost savings per gram of catalyst 20 when using a catalyst 20 on a support compared to when using a solid catalyst 20 particle.

Lastly, there may be enhancements of the catalytic activity of the highly dispersed catalyst 20 on the porous ceramic support layer 18 for promoting the combustion reaction. These enhancements are due to favorable chemical interactions between catalyst 20 and porous ceramic support layer 18 (so called support effects, which include but are not limited to, favorable alterations of surface properties, like surface acidity, surface tension, etc., resulting from the bonding of porous ceramic support layer 18 with the highly dispersed catalyst 20, thereby favorably altering catalyst interactions with fuel and/or oxidant).

During operation in the example embodiment of a chemical combustion heating reactor, chemical reactor 10 is characterized as giving off heat as a product (as noted by directional arrows 26) in proportion to the feed rate of input fuel 22 in the presence of sufficient or excess air 24. Accordingly, an input fuel inlet 28 is formed to provide for the inlet of input fuel 22 into ceramic cavity 16. Input fuel 22 in a preferred embodiment is hydrogen. Dependent upon use, alternate fuel sources, such as neat methanol, any admixtures of methanol and water, of methanol, water and hydrogen, and even mixtures of these previously mentioned fuels with any other hydrocarbon fuels, like methane, propane, butane, etc., can be used for input fuel 22. In addition, an air inlet 30 provides for the inlet of air 24 (comprised of mainly 20% oxygen and 80% nitrogen) into cavity 16. This input combination of input fuel 22 and air 24 moves through cavity 16, and comes in contact with catalyst 20, thereby generating heat 26 as the chemical product and indicated by directional arrows. It should be understood that anticipated by this disclosure is alternatively a single inlet which serves as a combination pre-mixed fuel/air inlet.

Additionally included as a part of device 10 is at least one temperature sensor 32. Temperature sensor 32 is provided to permit feedback control of the feed rate of fuel 22 and air 24 into ceramic cavity 16. Dependent upon desired temperature being reached and modification of that temperature, the feedback control provides for adjustment of the portions and proportion of fuel 22 and air 24 that enters ceramic cavity 16.

In this example of a chemical combustion heating reactor, during operation of chemical reactor 10, catalyst 20, formed with porous ceramic support layer 18, provides for the complete air oxidation of input fuel 22 with air 24. This oxidation provides for the generation of heat 26 as a chemical product which is dissipated through ceramic structure 12. There is provided an outlet 34 which allows for the output 36 of any chemical reactants not converted during operation, such as uncombusted fuel 22 and air 24, and any by-products of the chemical reaction such as carbon dioxide (CO₂), water (H₂O), nitrogen (N₂) or lost heat, generated within ceramic cavity 16. Accordingly, chemical reactor 10 is described as generating heat that is dissipated from ceramic cavity 16 through ceramic structure 12. Similarly and analogously, chemical reactor 10, when operating as steam reforming chemical reactor can be described as absorbing heat 26 (with direction of the arrows in the opposite direction). During operation as a steam reforming chemical reactor, catalyst 20, formed with porous ceramic support layer 18, converts input chemical reactants 22 and steam 24 into product materials such as water vapor, carbon dioxide (CO₂), carbon monoxide, nitrogen (N₂) (from the air) and hydrogen gases.

Referring now to FIG. 2, illustrated in simplified sectional view is a second embodiment of a chemical reactor according to the present invention, referenced 10′. It should be noted that all components of FIG. 2 that are similar to the components illustrated in FIG. 1, are designated with similar numbers, having a prime added to indicate the different embodiment. Chemical reactor 10′ is formed using multi-layer ceramic technology, and is thus comprised of a ceramic material 12′. Chemical reactor 10′, which in this particular embodiment is formed as a chemical combustion heating reactor, includes a ceramic structure 12′ formed of a plurality of ceramic layers 14′ defining therein a plurality of ceramic structures 15. Defined by ceramic structures 15, within a ceramic cavity 16′, are a plurality of channels 19. Channels 19 provide for the control of flow of input chemical reactants such as fuel 22′ and air 24′ within ceramic structures 15 defined within ceramic cavity 16′. It should be understood that any number of channels 19 are anticipated by this disclosure and it should not be limited to the number illustrated in the drawings.

Plurality of ceramic structures 15 have coated thereon a surface, a porous ceramic support layer 18′ (as illustrated in FIG. 2), which provides for protection of a subsequent material layer from the deactivating impurities present in the ceramic material forming ceramic structures 15 defined within a ceramic cavity 16′. Porous ceramic support layer 18′ is disclosed as formed of a high surface area material, such as a porous ceramic material, thereby characterized as a pure high surface area support. In this particular embodiment, porous ceramic support layer 18′ is disclosed as being formed of alumina (Al₂O₃), silica (SiO₂), titanium dioxide (TiO₂), zirconium dioxide (ZrO₂), cerium dioxide (CeO₂), lanthanum oxide (La₂O₃), or a combination of at least two of these high surface area support material that will prevent the migration of deactivating impurities.

Similar to the embodiment described and shown in FIG. 1, during fabrication of device 10′, plurality of ceramic layers 14′ forming dense ceramic structure 12′ and porous ceramic support layer 18′ are cofired together. Porous ceramic support layer 18′ is further described as being deposited on a plurality of surfaces of ceramic structures 15 defined within a ceramic cavity 16′ in the channeled configuration. Typically, porous ceramic support layer 18′ is screen printed from a thick film paste, or deposited via a slurry coating, onto ceramic structure 12′ in its green or unfired state during assembly. Porous ceramic support layer 18′ is then cofired with the green ceramic structure 12′ to yield a porous region of high specific surface area suitable for a catalytic support that is well adhered to the dense ceramic structure 12′ and more particularly to ceramic channel structures 15.

As illustrated in FIG. 2, porous ceramic support layer 18′ is formed in combination with a catalyst 20′. More specifically, catalyst 20′ is formed on a plurality of surfaces of porous ceramic support layer 18′. Porous ceramic support layer 18′ provides for the isolation of active catalyst 20′ from the bulk ceramic structure 12′. Alternatively, or in addition to, catalyst 20′ may be embedded in the porous ceramic material, or more specifically in porous ceramic support layer 18′. In the example of a chemical combustion heating reactor, catalyst 20′ serves to further define channels 19 and allows for complete air oxidation (discussed presently) of an input chemical reactant, namely fuel 22′, with air 24′. In addition, there is optionally provided as illustrated in the embodiment of FIG. 2, a porous ceramic felt 21 formed having a catalyst 18′ entrapped therein. Porous ceramic felt 21 is defined by either a plurality of woven or non-woven fibers. As stated, the inclusion of porous ceramic felt 21 or the embedding of catalyst 20′ in porous ceramic support layer 18′ is optional, and will further promote a more efficient device 10′ in the conversion of fuel 22′ and air 24′ to heat 26′.

Catalyst 20′, similar to the embodiment described in FIG. 1, is formed by the impregnation of hydrated metal salts, such as cupric nitrate (Cu(NO₃)₂.3H₂O), zinc nitrate (Zn(NO₃)₂.6H₂O), dihydrogenhexachloroplatinate (H₂PtCl₆.6H₂O), or palladium nitrate (Pd(NO₃)₂.2H₂O) which are then fired to decompose the salts to their metallic catalytic species. Porous ceramic support layer 18′ is described as being a high surface area support, such as alumina (Al₂O₃), silica (SiO₂), titanium dioxide (TiO₂), zirconium dioxide (ZrO₂), cerium dioxide (CeO₂), lanthanum oxide (La₂O₃) or any combination of these high surface area supports. Alternatively, catalyst 20′ is formed of an active metal such as silver (Ag), palladium (Pd), nickel (Ni), or the like. Various active metal oxides, active metal oxychlorides and active metal oxynitrides can act as alternative catalyst materials to noble metals like platinum (Pt) as combustion catalysts and as performance enhancing supports for combustion catalyst materials. These mixed metal ionic species have compositions of positive metal ions, like ferrous ion (Fe⁺²) or ferric ion (Fe⁺³), and negative ions, like oxide ion (0⁻²), chloride (Cl⁻¹), or nitride (N⁻³).

Active transition metal oxides such as a manganese oxide (MnO, MnO₄, MnO₆), cobalt oxide (Co₂O₃), molybdenum oxide (MoO₂, Mo₂O₃, or Mo₂O₅), chrome oxide (Cr₂O₃), can be defined using iron oxide (FeₓO_{y}) as an example, where a family of active metal oxides (MₓO_{y}) with M is any transition metal, preferably from Groups VIA, VIIA, and VIIIA, consisting of active metal oxides with x=1 and y=1 (e.g., FeO) or x=2 and y=3 (e.g., Fe₂O₃), and admixtures thereof (e.g., Fe₃O₄ forms by mixing the FeO and Fe₂O₃ in a 1 to 1 ratio). In general, these active metal oxides can be expressed as M_{x+x′}O_{Y+Y′}:

e.g., for FeO, FeₓO_{y} with x=0 to 1 and y=x;

and for Fe₂O₃ we have x′=0 to 2 and y′=3/2x′ y′=y(3/2),

and then admixtures thereof can be formulated as Fe_{x+x′}O_{y+y′}.

e.g., for the 1 to 1 iron oxide admixture, Fe₃O₄;

we have x=1, x′=2 and y=1 and y′=3.

Using iron oxide (FeₓO_{y}) as an example, a family of active metal oxychlorides can be defined and expressed as, M_{x+x′}O_{y+y′}Cl_{z+z′}, where M is any transition metal, preferably from Groups VIA, VIIA, and VIIIA of the Periodic Table, and x=1 or 2, y=1 or 3, and z=0 to 6.

e.g., for FeO_{y-z}Cl_{z}, x=1, y=x−z/2 and z=0 to 2x;

for Fe_{x′}O_{y′}Cl_{z′}, x′=1 or 2 and y′=(3/2)*x′-z′/2 and z′=0 to 3x

e.g., for Fe₂O₂Cl₂ x′=2; z′=1x; then y′=(3/2)*2−2/2=2

and admixtures there of, Fe_{x+x′}O_{y+y′}Cl_{z+z′}

and for Fe₃O₃Cl₂, x=1, x′=2; z=2x=2; so y=x−z/2=0; z′=0 so y′=3/2*x′−z′=3 By analogy, similar formulations can be made for active metal oxynitrides and their mixtures with chloride and all admixtures.

In general other metals and combinations of metals with anions, e.g., like ZrOCl₂, AlOCl, and mixed metal oxychlorides and oxynitrides, etc., can be useful as combustion catalysts and supports for combustion catalysts, and it should additionally be understood that anticipated is a catalyst 20′ formed of any combination of active metals, active metal oxides, active metal oxychlorides, and active metal oxynitrides.

Catalyst 20′ is disclosed as being formed within channels 19 by dispersion of a powder onto the surface of porous ceramic support layer 18′, or by providing for a monolithic layer formation on the surface of porous ceramic support layer 18′. Channels 19 provide for a more efficient device 10′ in that they provide for maximum utilization of catalyst 20′ and maximum optimization of the extent of conversion of the combustion of fuel 22′ and the oxidant air 24′ in the example embodiment of a chemical combustion heating reactor. These enhancements with catalyst 20′ on porous ceramic support layer 18′ result from catalyst 20′ being isolated from any other materials except fuel 22′, air 24′, and porous ceramic support layer 18′ (that is the porous ceramic support layer 18′ support serves as an actual barrier) and from increased dispersing of the catalysts, that is an increased surface area of the catalyst per unit of mass of catalyst 20′ resulting when catalyst 20′ is dispersed by depositing catalyst 20′ onto porous ceramic support layer 18′.

During operation in the example embodiment of a chemical combustion heating reactor, chemical reactor 10′ is characterized as giving off heat (as noted by directional arrows 26′) in the same manner as described with respect to the previous embodiment of FIG. 1. Chemical combustion heating reactor 10′ generates heat 26′ in proportion to the feed rate of an input fuel in the presence of a sufficient or excess input air. It should be understood that when reactor 10′ is formed as a steam reforming reactor, reactor 10′ would include heat absorption with opposite directional arrows 26′. Accordingly, similar to the embodiment illustrated in FIG. 1, an input fuel inlet 28′ is formed to provide for the inlet of input fuel 22′ into ceramic cavity 16′ having defined therein a plurality of ceramic structures 15 further defining a plurality of channels 19. Input fuel 22′ in a preferred embodiment is hydrogen, but an alternate fuel source, such as neat methanol, any admixtures of methanol and water, of methanol, water and hydrogen, or mixture of these previously mentioned fuels with any other hydrocarbon fuels, like methane, propane, butane, etc., can be used for input fuel 22′. In addition, an air inlet 30′ provides for the inlet of air 24′ (comprised of 20% oxygen and 80% nitrogen) into ceramic cavity 16′ having defined therein a plurality of ceramic structures 15 further defining a plurality of channels 19. This input combination of input fuel 22′ and air 24′ moves through the plurality of channels 19 defined by ceramic structures 15 within ceramic cavity 16′ as indicated by the directional arrows.

Additionally included as a part of device 10′, and similar to the embodiment illustrated in FIG. 1, is at least one temperature sensor 32′. Temperature sensor 32′ is provided to permit feedback control of the feed rate of fuel 22′ and air 24′ into ceramic cavity 16′. Dependent upon desired temperature being reached and modification of that temperature, the feedback control provides for adjustment of the portions and proportion of fuel 22′ and air 24′ that enters ceramic cavity 16′ having defined therein a plurality of ceramic structures 15 further defining a plurality of channels 19.

During operation of chemical reactor 10′ in the example embodiment of a chemical combustion heating reactor, catalyst 20′, entrapped within optional ceramic felt 21 and formed within or upon porous ceramic support layer 18′ in contact with each of the plurality of channels 19 defined by a plurality of ceramic structures 15 within ceramic cavity 16′, provides for the complete air oxidation of input fuel 22′ with air 24′. This oxidation provides for the generation of heat 26′ which is dissipated through ceramic structure 12′. There is provided an outlet 34′ which allows for the output of any uncombusted fuel 22′ and air 24′, and any additional combustion by-product 36′ such as carbon dioxide (CO₂), water (H₂O), nitrogen (N₂) or lost heat, generated within ceramic cavity 16′. Accordingly, chemical combustion heating 10′ is described as generating heat that is dissipated from each of the plurality of channels 19 defined by a plurality of ceramic structures 15 within ceramic cavity 16′ through ceramic structure 12′.

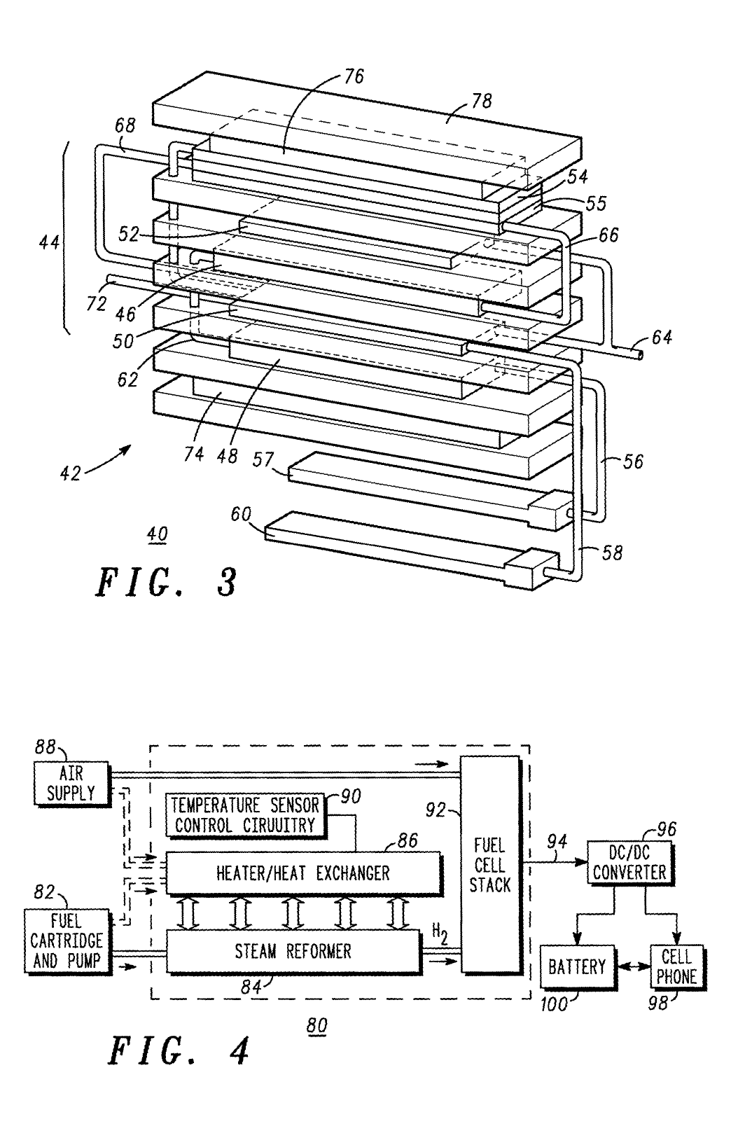

Referring now to FIG. 3, illustrated is a fuel processor system 40 according to the present invention, including a plurality of microfluidic channels and chemical reactors, which could be fabricated according to either of the previous embodiments disclosed in FIG. 1 or FIG. 2. Fuel processor system 40 is comprised of a three-dimensional multilayer ceramic structure 42. Ceramic structure 42 is formed utilizing multilayer laminate ceramic technology. Structure 42 is typically formed in component parts which are then sintered in such a way as to provide for a monolithic structure. Ceramic structure 42 has defined therein a fuel processor, generally referenced 44. Fuel processor 44 includes a reaction fuel reformer, 46, including a reaction zone formed generally similar to chemical reactor 10 when formed as a steam reforming reactor as described with respect to FIG. 1 or 10′ of FIG. 2. Fuel processor 44 further includes a vaporization chamber, or vaporization zone, 48, and an integrated chemical combustion heating reactor, 50, generally similar to chemical reactor 10 when formed as a chemical combustion heating reactor as described with respect to FIG. 1 or 10′ of FIG. 2. In addition, included as a part of fuel processor 44, is a waste heat recovery zone 52, and a fuel cell stack 54.

Ceramic structure 42 further includes at least one fuel inlet 56 formed to provide for fluidic communication with fuel vaporizer 48 and a liquid fuel source comprised of a combination solution of methanol and water 57. At least one fuel input inlet 58 is formed to provide for fluidic communication between a fuel source 60, and chemical combustion heating reactor 50. It should be understood that anticipated by this disclosure is a single fuel tank that is in fluidic communication with both fuel vaporizer 48 and chemical combustion heating reactor 50.

During operation of fuel processor 40, fuel 57 in fluidic communication enters fuel vaporizer 48 through fuel inlet 56 and is vaporized with the vaporous methanol and vaporous water (steam) exiting vaporizer 50 thought output 62 which is in fluidic communication with fuel reforming reactor 46. Fuel inlet 58 provides for the input of fuel to chemical combustion heating reactor 50. An air inlet provides for the input of air to chemical combustion heating reactor 50 and to waste heat recovery zone 52. Chemical combustion heating reactor 50 allows for complete air oxidation of fuel input 58 and subsequent dissipation of heat through structure 42 and more specifically, to fuel reforming reactor 46 and fuel vaporizer 48.

As previously stated, fuel 57 entering fuel vaporizer 48 is vaporized and the resultant vaporous methanol and water enters the reaction zone, or more specifically fuel reforming reactor 46, where it is converted to hydrogen enriched gas. There is provided a hydrogen enriched gas outlet channel 66 from reforming reactor 46 that is in fluidic communication with an inlet to fuel cell stack 54, and more particularly to a fuel cell anode 55. Fuel cell anode 55 provides for depletion of hydrogen from the hydrogen enriched gas mixture. This hydrogen depleted hydrogen enriched gas mixture exits fuel cell 54, and more particularly anode 55 through a fluidic communication 68 and is input to an inlet 70 of chemical combustion heating reactor 50. Chemical combustion heating reactor 50 oxidizes portions of this gas mixture to generate heat and provides for any uncombusted materials, such as remaining hydrogen and any carbon monoxide, to undergo air oxidation to water and carbon dioxide, and these as well nitrogen from air, are then vented through outlet 72 away from structure 42 into the atmosphere.

During operation, heat is efficiently transferred from the central aspect of the device, more particularly from chemical combustion heating reactor 50, to the reforming reactor 46 and fuel vaporizer, or vaporization zone 48 using thermal conductive channels (discussed presently). As previously described, output from fuel vaporizer zone 48 travels via channel 62 to fuel reforming reactor 46, and then through hydrogen enriched gas outlet channel 66 to fuel cell stack 54 to supply hydrogen fuel to stack 54. Spent gases from the fuel cell stack 54 are directed through a waste heat recovery zone 52 to capture the heat from the spent gases.

Efficient thermal insulators 74 and 76 are positioned around fuel processor system 44, under fuel vaporizer zone 48, and above fuel cell 54 to keep outer temperatures low for packaging and also to keep heat generated within the device localized to the fuel processor 44. As illustrated in FIG. 4, in this particular example, high temperature fuel cell stack 54 is integrated with fuel processor 44. This particular fuel cell design allows for the operation of the fuel cell at a temperature ranging from 140-230° C., with a preferred temperature of 150° C. Fuel vaporizer zone 48 operates at a temperature ranging from 120-230° C., with a preferred temperature of 180° C., and the fuel reforming reactor 46 operates at a temperature ranging from 180-300° C., with a preferred temperature of 230° C. Additionally, in this particular embodiment of ceramic structure 42 which is comprised of a fuel processor system 44 and fuel cell 54, included is a top cap 78.

It should be understood that alternative embodiments encompassing: (i) alternative fuel delivery means, either passive or active pumping; (ii) fuel vaporizer, reaction zone such as a reforming reactor, and chemical heater positions; and (iii) a fuel reformer device without an integrated fuel cell, are anticipated by this disclosure. In particular, anticipated is an embodiment in which only a single fuel supply, namely methanol, or methanol and water, is anticipated. This use of a single methanol, or methanol and water solution would enable the fabrication of a simpler design, without any need for the device to incorporate two fuel tanks. Although it is understood that pure methanol is more efficient and preferred with respect to the chemical combustion heating reactor, a 1 mole water and 1 mole methanol solution will also work, but is not deemed literally as operationally efficient. Further, a chemical combustion heater using the water and methanol solution is suitable for practical applications, and would permit a simple common fuel reservoir for feeding the chemical combustion heating reactor 50 and fuel reforming reactor 46. It should be understood that anticipated by this disclosure is a fuel processor system in which a single methanol solution is utilized with a means of recapturing water from the chemical combustion heating reactor outlet for mixing with an inlet fuel for fuel reforming.

Next, anticipated are variations on the actual design of system 40, and more particularly to the actual location of the fuel vaporizer zone 48, fuel reforming reactor 46 and chemical combustion heating reactor 50. In one particular alternative embodiment, it is anticipated that fuel reforming reactor 46 surrounds the chemical combustion heating reactor 50 on both sides (top and bottom). In yet another alternative embodiment, it is anticipated that fuel reforming reactor 46 can be positioned below chemical combustion heating reactor 50 and the fuel vaporizer zone 48 on top of chemical combustion heating reactor 50.

Finally, it is anticipated by this disclosure that although illustrated in FIG. 4 is the integration of fuel cell stack 54 with processor 44, a design in which a fuel cell is not integrated with reforming reactor 46 is anticipated. Further information on a reformed hydrogen fuel system device of this type can be found in U.S. patent application, bearing Ser. No. 09/649,528, entitled “HYDROGEN GENERATOR UTILIZING CERAMIC TECHNOLOGY”, filed Aug. 28, 2000, assigned to the same assignee and incorporated herein by this reference. When fuel cell stack 54 is integrated with fuel reforming reactor 46, advantage can be taken of the heat of the substrate to operate high temperature fuel cell stack 54. For high power applications, it is convenient to design a separate fuel cell stack 54 and a fuel processor unit 44 and couple them to supply the fuel for the fuel cell. In such instances, when a fuel cell stack is not integrated with the fuel processor, and the fuel processor is designed as a stand alone device, external connection can be made to connect the stand alone fuel processor to a traditional fuel cell stack for higher power applications.

Illustrated in FIG. 4 in a simplified flow chart diagram 80, is the fuel processor system 40 of FIG. 4, including a multilayer ceramic structure, a fuel processor, a fuel cell stack, insulators, and fuels, similar to previously described multilayer ceramic structure 42 having a fuel processor 44, fuel cell stack 54, insulators 74 and 76, and fuels 57 and 60 of device 40. As illustrated, a fuel cartridge, generally including an optional pump mechanism, 82 supplies water and methanol into a steam reformer 84, generally similar to fuel reforming reactor 46 of FIG. 4 and a chemical combustion heating reactor 86, generally similar to combustion heating reactor 50 and each generally similar to reactor 10 of FIG. 1, or reactor 10′ of FIG. 2. An air supply 88 provides for the supplying of air to chemical combustion heating reactor 86 and a fuel cell stack 92. Chemical combustion heating reactor 86 is monitored by a temperature sensor, including control circuitry, 90 thereby providing for steam reformer 84 to operate at a temperature of approximately 230° C. Operation of steam reformer 84 at this temperature allows for the reforming of input fuel 82 into a reformed gas mixture, generally referred to as the hydrogen enriched gas. More particularly, in the presence of a catalyst, such as copper oxide, zinc oxide, or copper zinc oxide, the fuel solution 82 is reformed into hydrogen, carbon dioxide, and some carbon monoxide. Steam reformer 84 operates in conjunction with an optional carbon monoxide cleanup (not shown), that in the presence of a preferential oxidation catalyst and air (or 0₂), reforms a large percentage of the present carbon monoxide into carbon dioxide. This reformed gas mixture supplies fuel through a fuel output to fuel cell 92, generally similar to fuel cell stack 54 of FIG. 3. Fuel cell 92 generates electricity 94 and is illustrated in this particular example as providing energy to a DC-DC converter 96, thereby supplying power to a cell phone 98 and/or battery 100.

Accordingly, described is a chemical reactor including at least one ceramic cavity formed therein and defining a geometric surface area. The chemical reactor can be formed as a chemical combustion heating reactor or a steam reforming reactor. A porous ceramic support layer, more specifically, a porous ceramic material is formed within the cavity and characterized as having a real surface area greater than the geometric surface area of the cavity. A catalyst material is formed in combination with the porous ceramic support layer, either positioned on a surface of the porous ceramic support layer, or entrapped within voids formed in the porous ceramic support layer. The catalyst is characterized as being immobilized and providing for i) complete air oxidation of an input fuel and the generation of heat in the embodiments for a chemical combustion heating reactor; and ii) reforming of an input fuel to a hydrogen enriched gas in the steam reforming reactor embodiments. The chemical reactor is formed as either a chemical combustion heater or a steam reformer for integration into a fuel processor. The chemical reactor is formed as a monolithically integrated structure, generally comprised of a plurality of thin ceramic layers that are assembled and having the porous ceramic material formed on a surface of the ceramic layers. During fabrication, the ceramic structure and the porous ceramic support layer are cofired prior to the introduction of the catalyst material, thereby providing for a closed reaction zone(s) in which the chemical reactor acts as a chemical combustion heater or a steam reformer.

While we have shown and described specific embodiments of the present invention, further modifications and improvements will occur to those skilled in the art. We desire it to be understood, therefore, that this invention is not limited to the particular forms shown or methods detailed, and we intend in the appended claims to cover all modifications that do not depart from the spirit and scope of this invention.

What is claimed is:

1. A chemical reactor comprising:
a ceramic carrier structure defining at least one ceramic cavity, the at least one ceramic cavity having a geometric surface area;
a cofired porous ceramic support layer formed within the at least one ceramic cavity, characterized as having a real surface area greater than the geometric surface area of the ceramic cavity; and
a catalyst material formed in combination within the porous ceramic support layer, the catalyst material characterized as providing for a chemical reaction which converts input chemical reactants into chemical products and by-products in the output.

2. A chemical reactor as claimed in claim 1 wherein the chemical reactor is one of a chemical combustion heater or a steam reformer.

3. A chemical reactor as claimed in claim 2 wherein the ceramic structure is a monolithic three-dimensional multilayer ceramic structure.

4. A chemical reactor as claimed in claim 3 wherein the monolithic three-dimensional multilayer ceramic structure is comprised of a plurality of thin ceramic layers and the porous ceramic support layer, assembled and cofired to provide for a closed reaction zone.

5. A chemical reactor as claimed in claim 4 wherein the porous ceramic support layer is formed of a porous ceramic material.

6. A chemical reactor as claimed in claim 5 wherein the porous ceramic material is formed by one of a screen printed paste, a pre-formed insert, or a deposited slurry coating.

7. A chemical reactor as claimed in claim 5 wherein the porous ceramic material is a high surface area support, formed of one of alumina (Al₂O₃), silica (SiO₂), titanium dioxide (TiO₂), zirconium dioxide (ZrO₂), cerium dioxide (CeO₂), lanthanum oxide (La₂O₃), or a combination of at least two of these high surface area supports.

8. A chemical reactor as claimed in claim 5 wherein the catalyst material is chosen from the group consisting of: a hydrated metal salt, an active metal, an active metal oxide, an active metal oxychloride, an active metal oxynitride, or a combination of an active metal and an active metal oxide.

9. A chemical reactor as claimed in claim 4 wherein the catalyst material is formed on a plurality of surfaces of the porous ceramic material.

10. A chemical reactor as claimed in claim 4 wherein the catalyst material is entrapped within a plurality of voids formed in the porous ceramic material.

11. A chemical reactor as claimed in claim 4 further including a porous ceramic felt positioned within the ceramic cavity and having entrapped therein the catalyst material.

12. A chemical reactor as claimed in claim 11 wherein the porous ceramic felt is defined by one of a plurality of woven fibers or a plurality of non-woven fibers.

13. A chemical reactor as claimed in claim 4 wherein a plurality of ceramic structures are formed within the ceramic cavity structure thereby defining a plurality of channels, the porous ceramic support layer being formed on a plurality of surfaces of the plurality of channels.

14. A chemical reactor as claimed in claim 1 further including at least one temperature sensor for providing feedback control of a feed rate of the input chemical reactant.

15. A chemical reactor comprising:
a monolithic three-dimensional multilayer ceramic structure, the monolithic three-dimensional multilayer ceramic structure comprised of a plurality of thin ceramic layers assembled to provide for at least one ceramic cavity having a geometric surface area, and thereby defining a closed reaction zone;
a porous ceramic support layer cofired with the monolithic three-dimensional multilayer ceramic structure and formed within the at least one ceramic cavity, the porous ceramic support layer characterized as having a real surface area greater than the geometric surface area of the ceramic cavity; and
a catalyst material formed in combination with the porous ceramic support layer, the catalyst characterized as providing for a chemical reaction which converts input chemical reactants into chemical products and by-products in the output.

16. A chemical reactor as claimed in claim 15 wherein the chemical reactor is formed as one of a chemical combustion heater or a steam reformer reactor.

17. A chemical reactor as claimed in claim 16 further including a plurality of ceramic structures formed therein the ceramic cavity structure and defining a plurality of channels.

18. A chemical reactor as claimed in claim 17 wherein the porous ceramic support layer is formed on the plurality of ceramic structures formed therein the ceramic cavity structure.

19. A chemical reactor as claimed in claim 16 wherein the porous ceramic support layer is formed of a porous ceramic material.

20. A chemical reactor as claimed in claim 19 wherein the porous ceramic material is formed by a screen printed paste, a pre-formed insert or a deposited slurry coating.

21. A chemical reactor as claimed in claim 19 wherein the porous ceramic material is a high surface support, formed of one of alumina (Al₂O₃), silica (SiO₂), titanium dioxide (TiO₂), zirconium dioxide (ZrO₂), cerium dioxide (CeO₂), lanthanum oxide (La₂O₃), or a combination of at least two of these high surface area supports.

22. A chemical reactor as claimed in claim 16 wherein the catalyst material is chosen from the group consisting of: a hydrated metal salt, an active metal, an active metal oxide, an active metal oxychloride, an active metal oxynitride, or a combination of an active metal and an active metal oxide.

23. A chemical reactor as claimed in claim 22 wherein the catalyst material is formed on a plurality of surfaces of the porous ceramic material.

24. A chemical reactor as claimed in claim 22 wherein the catalyst material is entrapped within a plurality of voids formed in the porous ceramic material.

25. A chemical reactor as claimed in claim 16 further including a porous ceramic felt defined by one of a plurality of woven fibers or a plurality of non-woven fibers positioned within the ceramic cavity and having entrapped therein the catalyst material.

26. A chemical reactor as claimed in claim 16 further including at least one temperature sensor for providing feedback control of a feed rate of the input chemical reactants.

27. A method of forming a chemical reactor comprising the steps of:
providing a ceramic material;
defining therein the ceramic material, at least one ceramic cavity, the at least one ceramic cavity having a geometric surface area;
depositing therein the at least one ceramic cavity a porous ceramic support layer;
cofiring the ceramic material and the porous ceramic support layer to form a ceramic carrier structure having the at least one ceramic cavity defined therein;
depositing a catalyst material in contact with the porous ceramic support layer, thereby forming an immobilized catalyst characterized as providing a chemical reaction which converts input chemical reactants into chemical products and by-products in the output.

28. A method of forming a chemical reactor as claimed in claim 27 wherein the step of depositing a porous ceramic support layer includes the step of depositing a porous ceramic material formed of one of alumina (Al₂O₃), silica (SiO₂), titanium dioxide (TiO₂), zirconium dioxide (ZrO₂), cerium dioxide (CeO₂), lanthanum oxide (La₂O₃), or a combination of at least two of these high surface area supports.

29. A method of forming a chemical reactor as claimed in claim 28 further including the step of forming a plurality of ceramic structures within the ceramic cavity thereby defining a plurality of channels, depositing the porous ceramic support layer on a surface of each of the plurality of channels, cofiring the ceramic material having the pluraltiy of channels defined therein and the porous ceramic support layer and impregnating the catalyst within the porous ceramic support layer formed on a plurality of surface of the plurality of channels.

30. A method of forming a chemical reactor as claimed in claim 28 wherein the step of cofiring the ceramic material and the porous ceramic support layer to form a ceramic carrier structure includes cofiring a plurality of thin ceramic layers and the porous ceramic support layer to provide for a closed reaction zone.

31. A method of forming a chemical reactor as claimed in claim 28 wherein the step of depositing a catalyst material in contact with the porous ceramic support layer includes the step of depositing a catalyst material chosen from the group consisting of: a hydrated metal salt, an active metal, an active metal oxide, an active metal oxychloride, an active metal

32. A method of forming a chemical reactor as claimed in claim 28 wherein the step of depositing a catalyst material in contact with the porous ceramic support layer includes the step of entrapping the catalyst within at least one of a plurality of voids formed in the porous ceramic support layer and on a surface of the porous ceramic support layer.

33. A method of forming a chemical reactor as claimed in claim 28 further including the step of positioning a porous ceramic felt within the at least one ceramic cavity and entrapping therein the catalyst material.

34. A fuel processor comprising:
a ceramic carrier defining a plurality of chemical reactors, including a fuel reforming reactor and an integrated chemical combustion reactor, the fuel reforming reactor including a reaction zone including a reforming catalyst and the integrated chemical reactor thermally coupled to the reaction zone, wherein each of the plurality of chemical reactors has defined therein a ceramic cavity, a porous ceramic support layer, and an immobilized catalyst arranged to convert input chemical reactants into chemical products and by-products in the output to produce heat and hydrogen enriched gas;
a plurality of inlet channels for liquid fuel;
a plurality of outlet channels for hydrogen enriched gas; and
an integrated fuel cell, including an anode in microfluidic communication with the outlet channel of the fuel reforming reactor.

35. A fuel processor and integrated fuel cell as claimed in claim 34 wherein the fuel processor further includes a fuel vaporization zone.

36. A fuel processor as claimed in claim 34 wherein the integrated chemical combustion heating reactor further includes an air inlet for providing oxygen for the oxidation of the fuel and a fuel input inlet to provide fuel to the chemical reactor.

37. A fuel processor as claimed in claim 34 wherein the integrated chemical combustion heating reactor provides heat to the fuel vaporization zone and reaction zone of the fuel reforming reactor.

39. A fuel processor as claimed in claim 35 wherein the chemical reactors including a catalyst arranged to oxidize an input fuel to convert input chemical reactants into chemical products and by-products to produce heat and hydrogen enriched gas include a catalyst material chosen from the group consisting of: a hydrated metal salt, an active metal, an active metal oxide, an active metal oxychloride, an active metal
